(19) United States
(12) Patent Application Publication
(10) Pub. No.: US 2009/0222765 A1
(43) Pub. Date: Sep. 3, 2009

(54) ADAPTIVE THUMBNAIL SCROLLBAR

(75) Inventor: Simon EKSTRAND, Eslov (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/040,318

(22) Filed: Feb. 29, 2008

(51) Int. Cl. G06F 3/048

(52) U.S. Cl. 715/818

(57) ABSTRACT

A user interface and method for electronic devices, such as mobile phones, having an adaptive scrollbar for indicating to a user the relative position of the data displayed with respect to the other data stored in memory. The scrollbar can indicate the relative position of displayed data such as icons, thumbnails, etc. in both the vertical and horizontal directions. The scrollbar can be configured to appear on the display only when useful to a user, such as when a user rapidly depresses a button to scroll through items.

### TECHNICAL FIELD OF THE INVENTION

The present invention relates generally to electronic equipment and, more particularly, to a scrollbar for a display.

### DESCRIPTION OF THE RELATED ART

Conventional mobile phones, in addition to providing voice communication capabilities, also provide a number of non-voice related features. For example, mobile phones can be used to surf the internet, transmit and receive messages (e.g., emails and text messages), play music and videos, take and display photographs, as well as a number of other features. Some mobile phones, often referred to as “Smart Phones,” provide many of the same functions as a personal computer.

Control of a mobile phone is typically effected through a plurality of buttons operable to navigate through a graphical user interface of the phone to place and receive calls, send and receive text messages and/or email, play music and/or video, take and display photographs, etc. As will be appreciated, the display size of a phone is limited due to overall size constraints on the mobile phone, and the trend towards smaller, thinner phones. Accordingly, the space available for viewing objects on the display is limited.

When a user is viewing a large number of items, for example thumbnails of pictures stored in the phone's memory, it can be difficult for the user to ascertain the location of the displayed images with respect to all of the images stored in memory (e.g., the images not displayed). Thus, a user may waste time looking for a particular image by scrolling through various images in a first direction, only to find that the desired image could have been more quickly located by scrolling in the opposite direction.

### SUMMARY

The present invention provides a user interface and method for electronic devices, such as mobile phones, having an adaptive scrollbar for indicating to a user the relative position of the data displayed on a display with respect to the other data stored in memory and not displayed on the display. The scrollbar can indicate the relative position of displayed data such as icons, thumbnails, etc. in both the vertical and horizontal directions. The scrollbar can be configured to appear on the display only when useful to a user, such as when a user rapidly depresses a button to scroll through items.

One aspect of the technology relates to a user interface comprising a plurality of graphical identifiers each of which identifies an object stored in memory, the graphical identifiers being presentable in an array in which only a portion of the array is displayed to a user, and a position indicator displayable to a user and operative to indicate relative horizontal and vertical position of the portion of the array being displayed within the array of graphical identifiers.

According to another aspect, the user interface further comprises a plurality of indicators arranged in an array representing the array of graphical identifiers, wherein the position indicator includes at least one of the plurality of indicators.

According to another aspect, the position indicator includes an indicator that is visually distinguishable from adjacent indicators to thereby denote position.

According to another aspect, the plurality of indicators arranged in an array includes rows and columns corresponding to rows and columns of the array of graphical identifiers.

According to another aspect, the array of the plurality of indicators includes at least one separator for separating indicators corresponding to graphical identifiers having different predetermined characteristics.

According to another aspect, the predetermined characteristics include at least one of a date, time, location, file type, file size, etc.

According to another aspect, the position indicator is scalable to provide a relative indication of the size of the array of graphical identifiers.

According to another aspect, the position indicator is displayable together with the portion of the array of graphical identifiers displayed to the user.

According to another aspect, the position indicator is partially transparent and overlayed on at least one graphical identifier visible through the position indicator.

According to another aspect, the position indicator is displayed in response to a user input.

According to another aspect, the position indicator is dynamic so as to indicate the relative horizontal and vertical position of the portion of the array being displayed when the dimension of the array of graphical identifiers changes.

According to another aspect, an electronic device includes the user interface.

According to another aspect, the electronic device is a mobile phone.

According to another aspect, the electronic device is at least one of a personal audio device, a personal video device or a personal digital assistant.

Another aspect of the technology includes a method of indicating a position within a plurality of graphical identifiers displayable in an array of which less than the entire array is displayed, the method comprising displaying at least one graphical identifier of the array of graphical identifiers, and displaying an array of indicators corresponding to the array of graphical identifiers. At least one of the indicators is a position indicator corresponding to the position of the displayed at least one graphical identifier within the array of graphical identifiers.

According to another aspect, the displaying the array of indicators is in response to a user input.

According to another aspect, the user input includes scrolling.

According to another aspect, the displaying includes overlaying the array of indicators on the at least one graphical identifier.

According to another aspect, the method further comprises dynamically updating the position indicator to indicate the relative horizontal and vertical position of the portion of the array being displayed when the dimension of the array of graphical identifiers changes.

According to another aspect, the method further comprises generating at least one separator configured to separate indicators corresponding to graphical identifiers having different predetermined characteristics.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an illustration of an exemplary mobile phone.

FIG. 2 is a schematic block diagram of the relevant portions of the mobile telephone of FIG. 1 in accordance with an embodiment of the present invention.

FIG. 3 is a schematic illustration of a typical display displaying a plurality of graphical identifiers in an array.

FIG. 4 is a schematic illustration of the display of FIG. 3 including an exemplary position indicator.

FIG. 5 is another schematic illustration of a display including an exemplary position indicator.

FIG. 6 is still another schematic illustration of a display including an exemplary position indicator.

FIG. 7 is yet another schematic illustration of a display including an exemplary position indicator.

FIG. 8 is a schematic illustration of a display including an exemplary position indicator indicating the displayed graphical identifier is the last in the array of graphical identifiers.

FIG. 9 is a schematic illustration of a display including an exemplary position indicator indicating the displayed graphical identifier is the first in the array of graphical identifiers.

FIG. 10 is a schematic illustration of an exemplary implementation of a scrollbar function in accordance with the invention.

FIG. 11 is a flowchart illustrating an exemplary method in accordance with the invention.

### DETAILED DESCRIPTION OF EMBODIMENTS

The present invention will now be described with reference to the drawings, wherein like reference numerals are used to refer to like elements throughout.

The term “electronic equipment” and/or “electronic device” includes portable radio communication equipment. The term “portable radio communication equipment,” which herein after is referred to as a “mobile radio terminal,” “mobile phone,” “mobile device,” or “mobile terminal”, and the like, includes all equipment such as mobile telephones, pagers, communicators, i.e., electronic organizers, personal digital assistants (PDAs), smartphones, portable communication apparatus or the like.

In the present application, the invention is described primarily in the context of a mobile phone. However, it will be appreciated that the invention is not intended to be limited to a mobile phone and can be any type of electronic equipment. As will be appreciated, the invention is applicable to both portable devices (e.g., hand held mobile phones) and non-portable devices (e.g., devices integrated within a vehicle, such as an integrated telematics system).

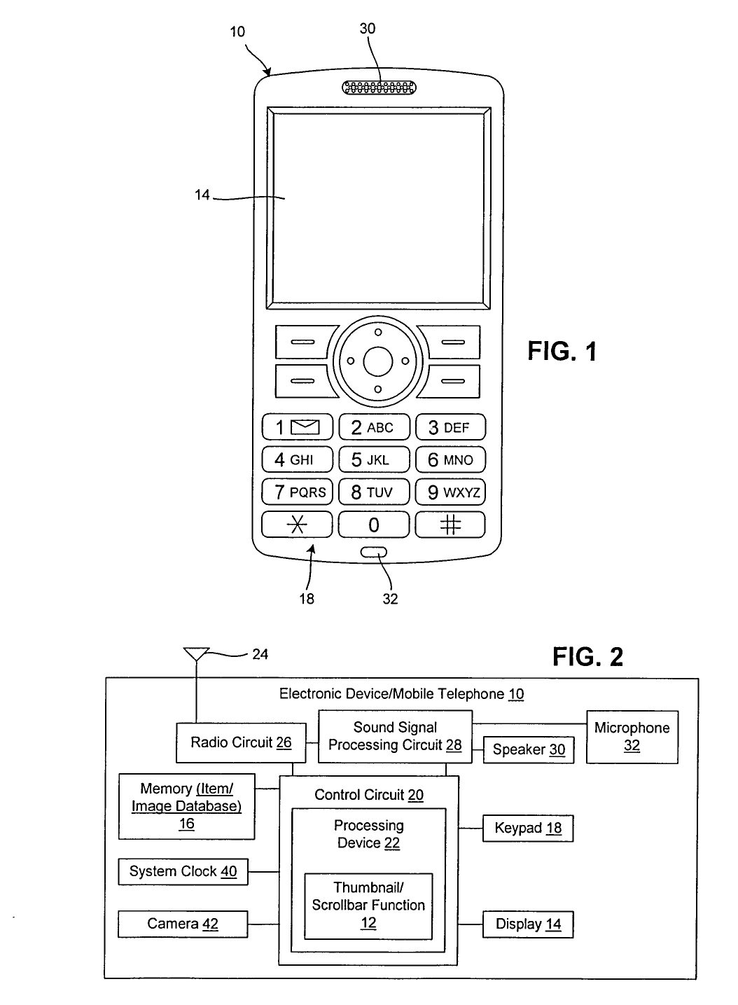

Referring initially to FIGS. 1 and 2, an electronic device 10 is shown. The electronic device 10 includes an scrollbar function 12 that is configured to generate and display a scrollbar to a user. Additional details and operation of the scrollbar function 12 will be described in greater detail below. The scrollbar function 12 may be embodied as executable code that is resident in and executed by the electronic device 10. In one embodiment, the scrollbar function 12 may be a program stored on a computer or machine readable medium. The scrollbar function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for simple message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

In addition, the processing device 22 may execute code that implements the scrollbar function 12. It will be apparent to a person having ordinary skill in the art of computer programming, and specifically in application programming for mobile telephones or other electronic devices, how to program a mobile telephone 10 to operate and carry out logical functions associated with the scrollbar function 12. Accordingly, details as to specific programming code have been left out for the sake of brevity. Also, while the scrollbar function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit (not shown) that converts video data to a video signal used to drive the display 14. The video processing circuit may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures and/or movies. Image and/or video files corresponding to the pictures and/or movies may be stored in the memory 16 and displayed on the display 14.

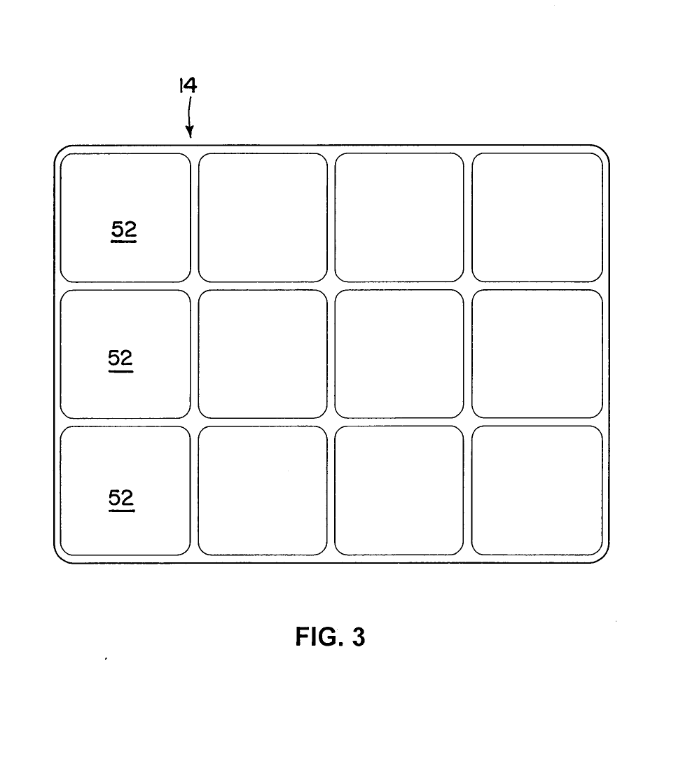

Turning now to FIG. 3, the display 14 is shown with a plurality of graphical identifiers 52, which may be icons, thumbnails, or the like, displayed in an array thereon. The graphical identifiers 52, as is typical, are linked to respective objects stored in a memory of the phone 10. For example, the graphical identifiers 52 can be thumbnails of respective images stored in memory. It will be appreciated that the graphical identifiers 52 can be associated with any type of data stored in memory, including pictures, movies, data entries such as contact lists, files, etc.

The array of graphical identifiers 52 presented on the display 14 as shown in FIG. 3 most typically represents only a portion of the corresponding pictures, movies, files, etc. stored in memory. The identifiers 52 shown on the display 14 do not provide the user with any information to determine 1) if there are more graphical identifiers 52 in the array that are not shown on the display 14, or 2) the relative location of the displayed graphical identifiers with respect to any additional graphical identifiers not shown on the display 14.

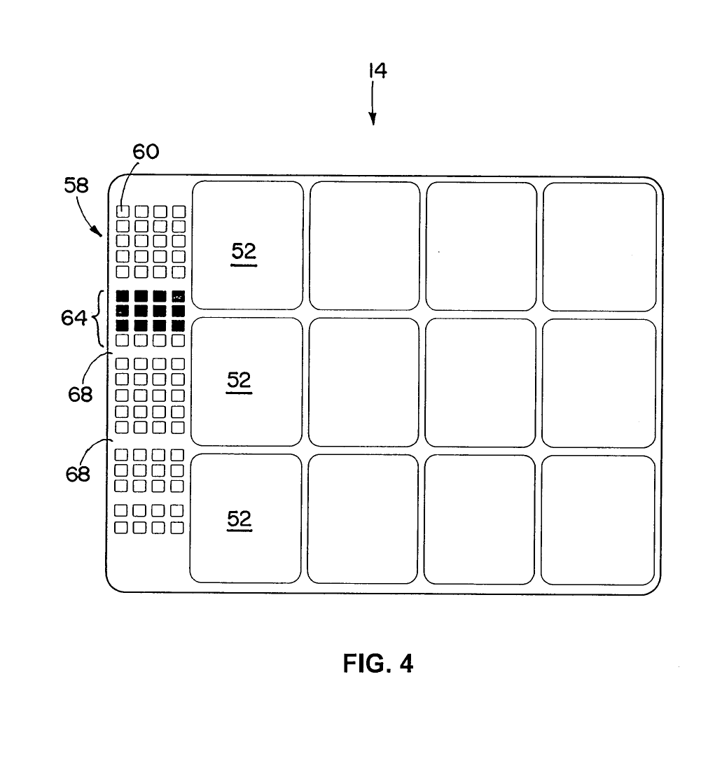

Turning to FIGS. 4-9, and in accordance with the invention, the display 14 is illustrated including a position indicator 58 operative to indicate the relative horizontal and vertical position of the portion of the array being displayed in the display 14. The position indicator 58 includes a plurality of indicators 60 arranged in an array having rows and columns that generally correspond proportionally to the dimensions of the array of graphical identifiers 52. Thus, the position indicator 58 in FIG. 4 has four columns corresponding to the four columns of graphical identifiers displayed on the display 14. As will be appreciated, three rows of the position indicators 60, generally indicated by reference numeral 64, are shaded to thereby denote the relative position of the portion of the array of graphical identifiers displayed on the display 14. Accordingly, the position indicator 58 allows a user to ascertain the location within the array of graphical identifiers of the currently displayed graphical identifiers 52. The indicators 60 above and below the shaded indicators 64 represent additional graphical identifiers within the array that are not displayed on the display 14.

As a user scrolls through the array of graphical identifiers 52, such as by activating a user input (e.g., a scroll button), the identifiers 52 shown on display 14 will change. The shaded indicators 64 can change in relation to the change in displayed identifiers 52 such that the user can always determine the relative location of the displayed identifiers 52 within the array of identifiers.

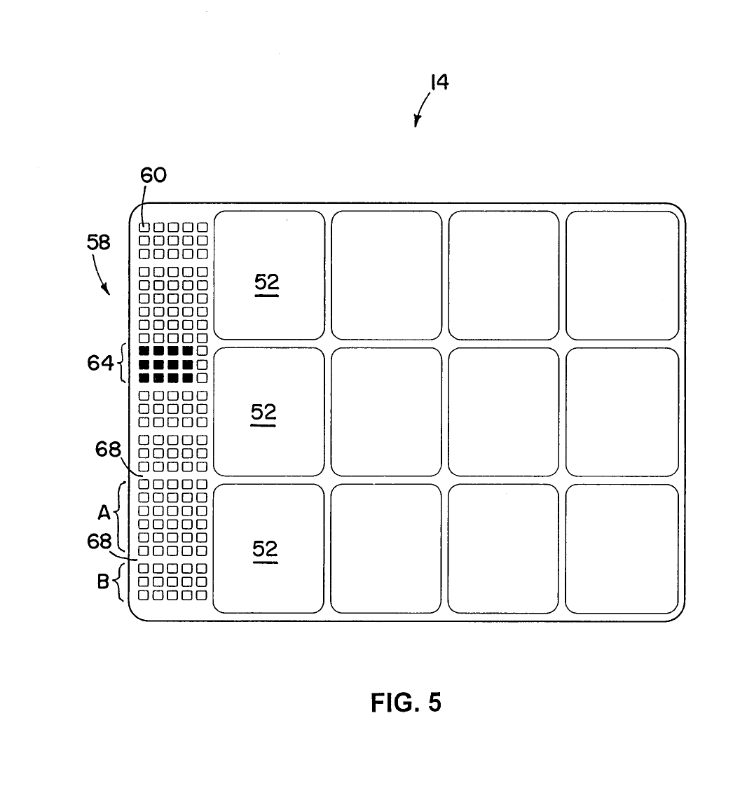

Turning now to FIG. 5, another version of the display 14 is illustrated having three rows and four columns of graphical identifiers 52 displayed thereon. In this embodiment, the position indicator 58 indicates that not only are additional rows of graphical identifiers above and below the displayed rows of graphical identifiers, but also that an additional column of graphical identifiers is located to the right of the right most displayed column of graphical identifiers 52. Thus, in this embodiment the position indicator indicates both the horizontal and vertical position of the portion of the array of graphical identifiers 52 displayed on the display 14. Of course, as a user scrolls through the graphical identifiers, the shaded indicators can change to always indicate the position of the currently displayed identifier.

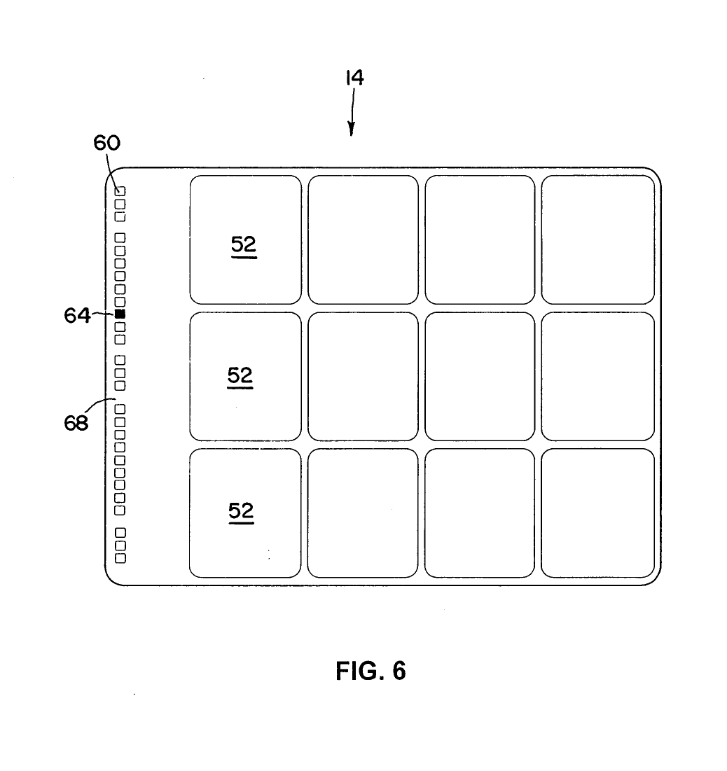

In some instances the dimensions of the array of graphical identifiers 52 may be such that a direct correlation between the number of columns in the array of graphical identifiers 52 and the number of columns of the indicators 60 is not possible and/or may not be desirable. In such case, and as shown in FIG. 6, the position indicator 58 may have fewer columns than the number of columns displayed on the display 14 of array of graphical identifiers 52. In FIG. 6, a single column of indicators 60 represents a very large number of graphical identifiers 52. In this configuration the position indicator 58 mainly indicates the relative vertical position of the portion of the array of graphical identifiers 52 being displayed on the display 14. The size of the position indicator 58 can be proportional to the size of the array. For example a 1:1, 5:1, 30:1, 100:1, etc. relationship can be employed depending on the size of the array of graphical identifiers.

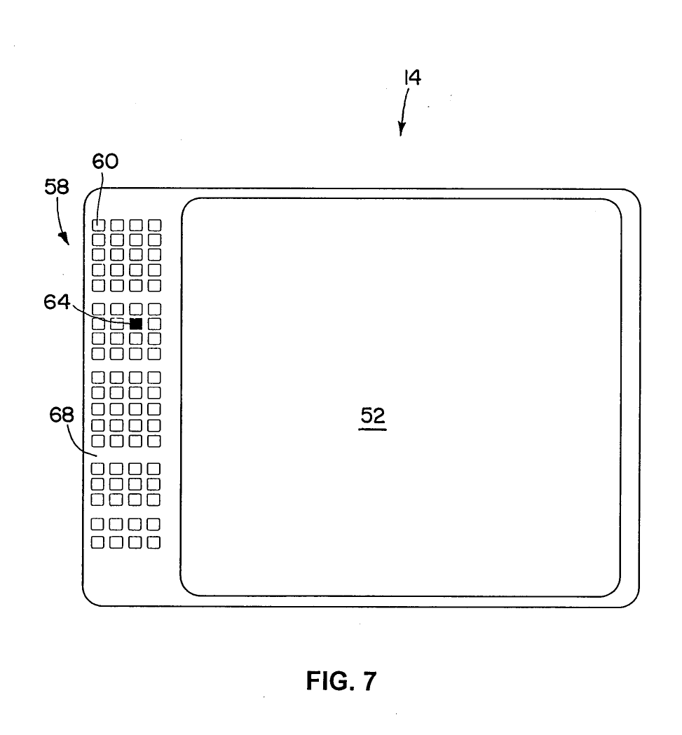

As illustrated in FIG. 7, in the event a single graphical identifier 52 is displayed on the display 14, the position indicator 58 can be configured to display to the user the relative horizontal and vertical position of the single graphical identifier 52, indicated by shaded indicator 64.

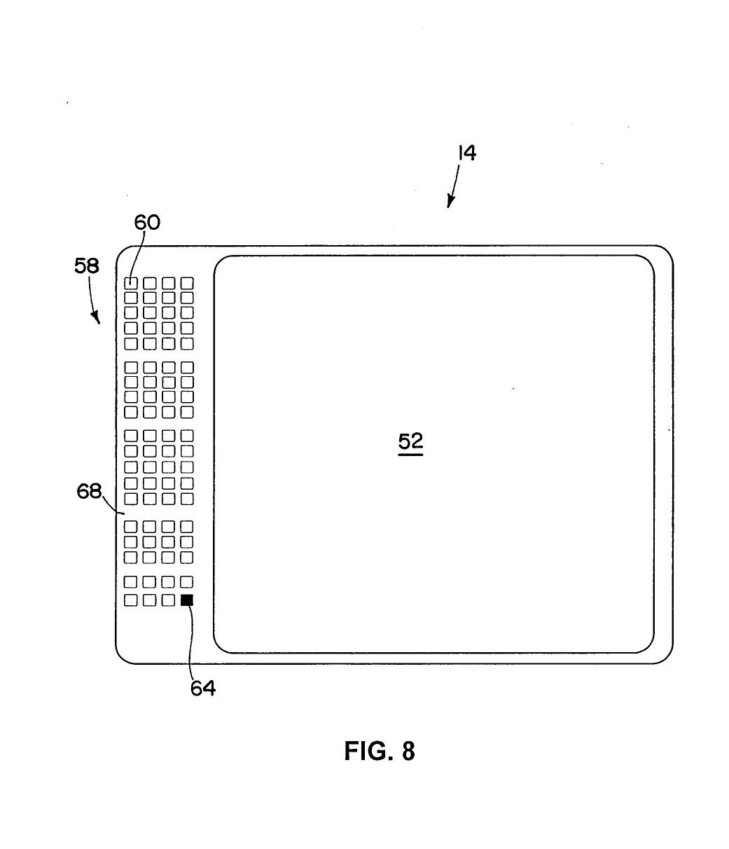

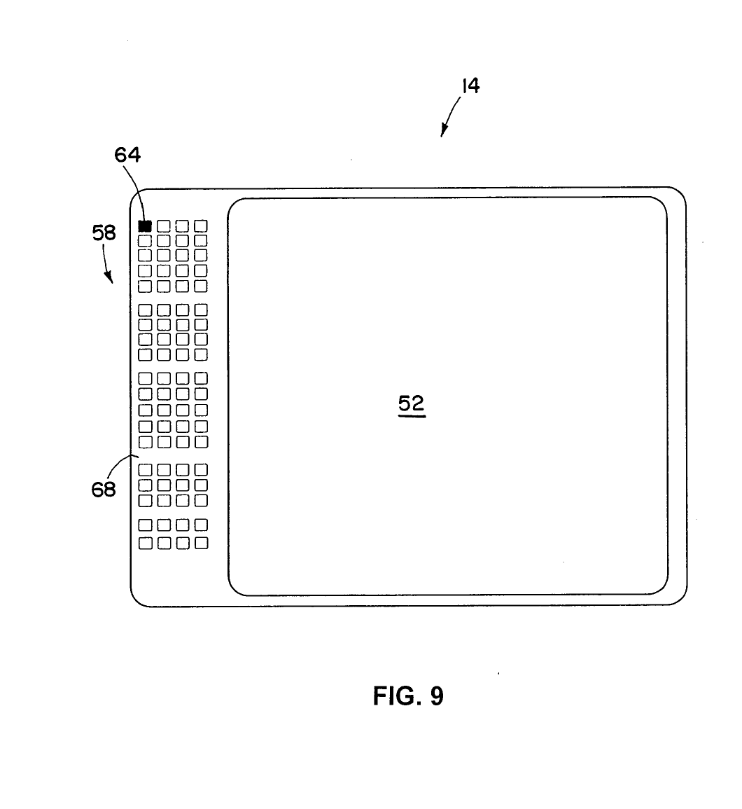

In FIGS. 8-9, the respective last and first graphical identifiers 52 in the array of graphical identifiers 52 are shown on the respective displays 14. As will be appreciated, the shaded indicator 64 in FIG. 8 corresponds to the bottom right graphical identifier 52 displayed on the display 14. In typical fashion, a user will typically have scrolled or otherwise advanced through the array of graphical identifiers 52 to the position of the last graphical identifier 52 in the array. The position indicator 58 can be configured to alert the user that the displayed graphical identifier 52 is the last graphical identifier within the array. For example, the indicator may flash or otherwise exhibit a characteristic indicative of the end of the array.

Further scrolling by the user can then revert the display 14 to the first graphical identifier 52 in the array, as shown in FIG. 9. During the transition from the last graphical identifier 52 to the first graphical identifier 52 in the array (e.g., from FIG. 8 to FIG. 9), the shaded position indicator 64 can be configured to “travel” or otherwise revert to the starting position of the first graphical identifier as shown in FIG. 9. For example, when a user attempts to scroll beyond the position shown in FIG. 8, the displayed graphical identifier 52 can revert to the first graphical identifier in the array and the shaded position indicator can be configured to quickly return to the upper left most position by illuminating some or all of the indicators between the bottom right indicator and the top left indicator. As such, the shaded position indicator can appear to “travel” back to the beginning of the array. Other transitions from the position indicator shown in FIG. 8 to the position indicator shown in FIG. 9 are possible. For example, the position indicator can be configured to disappear or fade out before reappearing as the position indicator shown in FIG. 9. Another possibility would be for all of the indicators to pulse or otherwise change characteristics prior to the position indicator reverting to the position of FIG. 9.

As should be apparent in FIGS. 4-9, gaps can be seen separating rows of indicators 60. Such gaps 68 can be used to distinguish groups of indicators corresponding to graphical identifiers 52 having different characteristics. For example, as shown in FIG. 5, a first group of indicators 60 generally indicated by the letter A, may correspond to graphical identifiers related to pictures taken during the same month of the year. Indicators of group B represent pictures taken during a month different than the images corresponding to the indicators of group A. Thus, the gap 68 between group A and group B distinguishes the indicators 60 of group A from the indicators 60 of group B. Gaps 68 can be used to separate indicators having different characteristics of a vide variety, for example, date (year, month, week, day, etc.), location, subject matter, event, file type, etc. The gaps (separators) can be spaces, lines, colors, etc.

It will be appreciated that the position indicator 58 can be configured to be displayed only during certain circumstances, such as when a user desires to scroll to a new part of the array of graphical identifiers 52. In this regard, the position indicator 58 can be configured to appear on the display 14, and may be superimposed over one or more of the graphical identifiers 58. By superimposing the position indicator 58 over one or more of the graphical identifiers 52 the maximum display area is available for thumbnail and/or image viewing, etc. The position indicator can be partially transparent thereby allowing an underlying graphical identifier to be visible through the position indicator.

In some instances, the number of graphical identifiers 52 in the array may be changing while a user is viewing a portion of the array on the display 14. For example, this may occur when new files are added to a folder in the memory. In such case, the position indicator can be dynamic and configured to automatically update to represent the relative position of the graphical identifiers 52 shown on the display 14 relative to the additional graphical identifiers 52 added to the array. Thus, at any given time a user can determine a relative location of the displayed graphical identifiers 52 within the array.

The position indicator 58 can also be configured to have a minimum impact on a users viewing experience of the display 14. In this regard, the position indicator can be configured to appear at times when a user is more likely to benefit from its presence on the display 14. For example, by monitoring the time interval of each press of a navigation wheel or other user input used for scrolling through the graphical identifiers, a determination can be made when a user begins to skip rapidly between graphical identifiers 52, and the position indicator 58 can be configured to appear on the display 14 and provide context thereby allowing the user to scroll rapidly through the array of graphical identifiers.

In this regard, the position indicator 58 can be configured to serve as a quick navigation interface. For example, on devices having a touch screen, after the appearance of the position indicator 58, a user can simply touch a region of the position indicator 58 and that portion of the array would then automatically be displayed on the display 14. During times when the user does not appear to be rapidly scrolling through the graphical identifiers 52 the position indicator 58 may not be shown on the display 14.

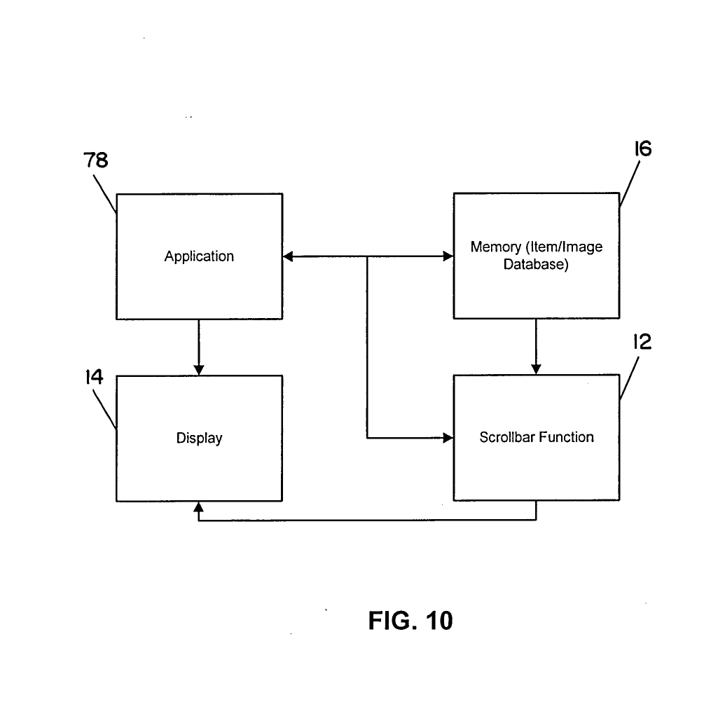

Turning now to FIG. 10, a system including an exemplary implementation of the scrollbar function 12 is schematically illustrated in a phone 10. The system generally includes an application 78, scrollbar function 12, display 14, and memory 16. As previously described, the scrollbar function 12 is typically executed by the processing device 22 (see FIG. 2), but of course may be executed by other means, such as a separate dedicated processor, for example. The application 96 can also be executed by processing device 22, or another device as desired.

The application 78 can be any application wherein the scrollbar described above can be used to give context to items displayed on the display 14. For example, the application 78 can be a photo album viewer, file explorer, etc. In general, the application 78 will access memory 16 and output one or more items/images to display 14, such as thumbnails, for example. The scrolbar function 12, being in communication with both the application 78 and the memory 16, can generate a scrollbar based upon the displayed items and the size of the array in which the displayed items exist. The scrollbar function 12 then sends the generated scrollbar to the display for operation in the manner described previously. As will be appreciated, the scrollbar function 12 can continually update the highlighted location of the displayed items in the scrollbar as a user scrolls through items, or as items are added to the array, for example.

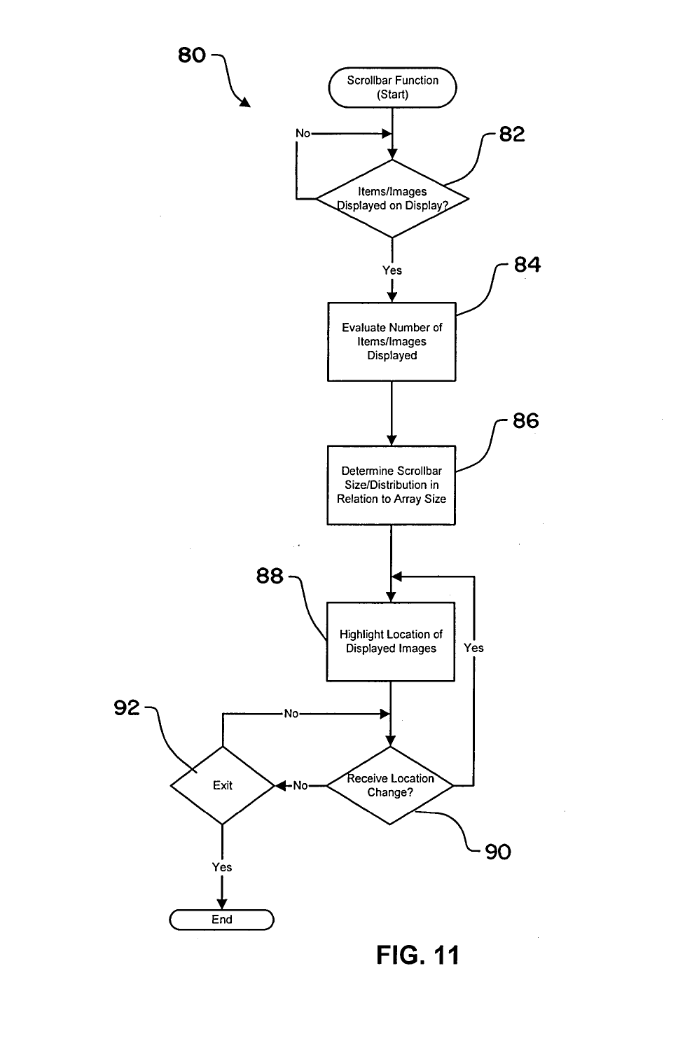

Turning to FIG. 11, a flowchart illustrates an exemplary method 80 in accordance with the invention. The method 80 begins with process step 82, wherein the scrollbar function detects whether an item or items, such as images, is displayed on the display. This can occur, for example, when a user is reviewing pictures stored in memory 16 using a photo viewer application. As will be appreciated, the displayed items/images can correspond to merely a portion of an array of items in memory 14, some of which typically will not be currently displayed. When an item/image is displayed, the number of items/images displayed is evaluated in process step 84.

After the number of items/images is evaluated, the scrollbar size and distribution is determined in process step 86. Generally, this determination is made by analyzing the displayed items/images with reference to the total items/images in the array stored in memory to determine a suitable scrollbar size and distribution. In process step 88, the scrollbar is then displayed on the display with the corresponding location of the displayed items/images highlighted. As will be appreciated, the display of the scrollbar can be in response to user input, such as a scrolling input, as previously described.

Once the scrollbar is displayed, the highlighted location can be continually updated such that it corresponds with the currently displayed items/images as a user scrolls through the array of items/images. Thus, in process step 90, if the location of the displayed images changes, the method reverts back to process step 88, and the scrollbar updates such that the new location is highlighted. If the location of the displayed images does not change, then the method continues to process step 92, and either terminates or reverts to process step 90 until the location of the displayed images changes.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A user interface comprising:
a plurality of graphical identifiers each of which identifies an object stored in memory, the graphical identifiers being presentable in an array in which only a portion of the array is displayed to a user; and
a position indicator displayable to a user and operative to indicate relative horizontal and vertical position of the portion of the array being displayed within the array of graphical identifiers
wherein the position indicator is at least one of a plurality of indicators arranged in an array representing the array of graphical identifiers.

2. A user interface as set forth in claim 1, wherein the position indicator includes at least one of the plurality of indicators that is visually distinguishable from adjacent indicators to thereby denote position.

3. A user interface as set forth in claim 1, wherein the plurality of indicators arranged in an array includes rows and columns corresponding to rows and columns of the array of graphical identifiers.

4. A user interface as set forth in claim 1, wherein the array of the plurality of indicators includes at least one separator for separating indicators corresponding to graphical identifiers having different predetermined characteristics.

5. A user interface as set forth in claim 4, wherein the predetermined characteristics include at least one of a date, time, location, file size, or file type.

6. A user interface as set forth in claim 1, wherein the position indicator is scalable to provide a relative indication of the size of the array of graphical identifiers.

7. A user interface as set forth in claim 1, wherein the position indicator is displayable together with the portion of the array of graphical identifiers displayed to the user.

8. A user interface as set forth in claim 1, wherein the position indicator is partially transparent and overlayed on at least one graphical identifier visible through the position indicator.

9. A user interface as set forth in claim 1, wherein the position indicator is displayed in response to a user input.

10. A user interface as set forth in claim 1, wherein the position indicator is dynamic so as to indicate the relative horizontal and vertical position of the portion of the array being displayed when the dimension of the array of graphical identifiers changes.

11. An electronic device including the user interface as set forth in claim 1.

12. An electronic device as set forth in claim 11, wherein the electronic device is a mobile phone.

13. The electronic device of claim 12, wherein the electronic device is at least one of a personal audio device, a personal video device or a personal digital assistant.

14. A method of indicating a position within a plurality of graphical identifiers displayable in an array of which less than the entire array is displayed, the method comprising:
displaying at least one graphical identifier of the array of graphical identifiers; and
displaying an array of indicators corresponding to the array of graphical identifiers;
wherein at least one of the indicators is a position indicator corresponding to the position of the displayed at least one graphical identifier within the array of graphical identifiers.

15. A method as set forth in claim 14, wherein the displaying the array of indicators is in response to a user input.

16. A method as set forth in claim 14, wherein the user input is includes scrolling.

17. A method as set forth in claim 14, wherein the displaying includes overlaying the array of indicators on the at least one graphical identifier.

18. A method as set forth in claim 14, further comprising dynamically updating the position indicator to indicate the relative horizontal and vertical position of the portion of the array being displayed when the dimension of the array of graphical identifiers changes.

19. A method as set forth in claim 14, further comprising generating at least one separator configured to separate indicators corresponding to graphical identifiers having different predetermined characteristics.
